(19) United States
(12) Patent Application Publication
(10) Pub. No.: US 2023/0324540 A1
(43) Pub. Date: Oct. 12, 2023

(54) Apparatus and Method for Identifying Transmitting Radio Devices

(71) Applicant: Nokia Technologies Oy, Espoo (FI)

(72) Inventors: Dalia POPESCU, Paris (FR); Jakob HOYDIS, Paris (FR); Luis UZEDA GARCIA, Massy (FR); Vinicius MESQUITA DE PINHO, Paris (FR)

(21) Appl. No.: 18/019,191

(22) PCT Filed: Jul. 26, 2021
(86) PCT No.: PCT/FI2021/050539

§ 371 Date: Feb. 1, 2023

(30) Foreign Application Priority Data
Aug. 5, 2020 (FI) 20205785

(51) Int. Cl. G01S 13/86; H04L 25/02

(52) U.S. Cl. CPC G01S 13/867; H04L 25/0212

(57) ABSTRACT

A method and an apparatus for identifying transmitting radio devices from a plurality of radio deviceswithin a video feed is described. At least one radio signal identifying a transmitting radio device is received, from the plurality of radio devices. A video feed identifying radio deviceswithin a field of view of the computer vision (CV)system is received, from the CV system. A first set of features is extracted from the received at least one radio signal and a second set of features is extracted from the received video feed. The first set of features and the second set of features are provided as an input to a machine learning (ML) algorithm to obtain a relationship between the transmitting radio device and the radio devicesidentified in the video feed.

### TECHNICAL FIELD

Various example embodiments relate to an apparatus and a method for identifying transmitting radio devices.

### BACKGROUND

In industrial private networks, 5G radio systems offer enhanced services to Industry 4.0, which have particular requirements that can be exploited. Such requirements include the use of radio devices that are operator owned devices, mainly robots and machines. Further, in an industrial environment (i.e. closed environment), there are numerous sensors and cameras and no privacy issues due to non-human users. It should be noted that industrial users have superior capabilities to sense the industrial environment. Such exploitation of the 5G radio systems facilitates improved communication among the radio devices over the same radio channel.

With 5G radio systems, radio device identification and positioning play an important role when deploying radio devices in industrial environments. Typically, in most industrial environments, wireless networks are used to track radio devices based on radio transmission from the radio devices. It should be noted that the wireless networks are telecommunication networks that use radio waves to carry information from one node to one or more receiving nodes. Such communication uses radio capabilities for capturing nearby radio transmissions. However, such usage of radio capabilities for tracking and identifying a plurality of radio devices, make use of resource demanding algorithms and methods.

Further, image capturing devices are used to track and position radio devices in the industrial environment. The image capturing devices may correspond to cameras, handheld devices with image capturing capability, laptop with webcam or any other computer vision system, or any other computer vision technologies. Such computer vision technologies use video or image recognition and provide visual proof for identification and positioning of the radio devices in the industrial environment. Further, such computer vision technologies are used to enhance spatial awareness, for example predicting blockages, proactive handover management, and radio resource management.

Further, various prototype implementations are available for identifying radio devices or user equipment in the computer vision system by making use of additional signaling, for example, indicating the computer vision system by means of an additional flashing signal such as by a blink of a light emitting diode (LED) for synchronization or radio-frequency identification (RFID) tags.

Further, methods are available for tracking a radio device in a visual field and a radio field after a handshake procedure and triggering mobility robustness optimization based on information provided by the image capturing device. Such methods work in real-time, use information from the computer vision system, to enhance radio, and assumes already existing matching procedure for the radio devices. However, such methods do not disclose an actual agreement between radio system and the computer vision system, for the identification of the radio device.

Therefore, there is a need for an improved apparatus and method for accurately identifying a radio device in both radio and computer vision domains within an industrial environment, which addresses the above-mentioned drawbacks.

### SUMMARY

The present disclosure addresses the above object by the subject-matter covered by the independent claims. Preferred embodiments of the invention are defined in the dependent claims.

According to a first aspect of the invention, there is provided an apparatus for identifying transmitting radio devices from a plurality of radio devices within a video feed. The apparatus may comprise means for receiving, from the plurality of radio devices, at least one radio signal identifying a transmitting radio device, means for receiving, from a computer vision (CV) system, a video feed identifying radio devices within a field of view of the CV system, means for extracting a first set of features from the received at least one radio signal, means for extracting a second set of features from the received video feed, and means for providing the first set of features and the second set of features as an input to a machine learning (ML) algorithm to obtain a relationship between the transmitting radio device and the radio devices identified in the video feed.

This provides an accurate and efficient way for identifying and matching a radio device in both the radio domain and the computer vision domain through means of machine learning. The obtained mapping between the radio domains and video feeds contributes to enhancing multi spectral, multi-sensory contextual navigation, as for example, implemented in the “MirrorWorld” concept through “Universal Maps”.

In some embodiments of the present invention, the at least one radio signal may comprise a radio measurement, in particular a channel impulse response (CIR) of the transmitting radio device, the apparatus being configured to extract the first set of features by determining a phase and a magnitude of the CIR, and determining from the magnitude of the CIR, a peak position, and a peak value.

In some embodiments of the present invention, the apparatus may be configured to extract the second set of features by performing visual detection on the video feed, preferably using a mask region-based convolutional neural network, to determine a respective bounding box (BBOX) for each radio device in the video feed, each bounding box comprising an identifier (BBOX_ID). Preferably, the bounding box is a region in the video feed or video stream that comprises the device.

In some embodiments of the present invention, the apparatus may be configured to periodically receive radio signals and the video feed, the radio signals being received with a first frequency and the video feed being received with a second frequency during a reception period, in particular the first frequency being higher than the second frequency; average the radio signals received to obtain an averaged radio signal, and merge the first set of features extracted from the averaged radio signal with the second set of features extracted from the video feed, using timestamps, to obtain the input for the ML algorithm.

The frequency of the acquisition of the radio frames is much higher than the frequency of the acquisition of the video frames. Therefore, the radio measurements are averaged for a period corresponding to one video measurement. Both data are merged using timestamps, which are easily provided by both systems. By averaging of the radio measurements, synchronization is achieved, and complexity is reduced.

In some embodiments of the present invention, the ML algorithm may be implemented using a random forest classifier (RFC) having a plurality of classification trees. Each classification tree is configured to process a subset of the first set of features and the second set of features. Preferably, the RFC may be configured to output a Boolean value indicative of whether the transmitting radio device is identified in the video feed. Alternatively, the RFC may be configured to output a mapping or a function identifying to which BBOX_ID the transmitting radio device belongs to.

In some embodiments of the present invention, the RFC may be configured to output a probability distribution over the bounding boxes, BBOX, in the video feed, indicating the probability of the transmitting radio device being one of the radio devices identified in the BBOXs. It should be noted that without the use of the ML algorithm, correct identification of the transmitting radio device among the plurality of radio devices would not be feasible, and thus result in improper tracking or identification of the radio devices.

According to a second aspect of the present invention, there is provided an apparatus for training a machine learning (ML) algorithm to obtain a relationship between a transmitting radio device and radio devices identified in a video feed. The apparatus may comprise means for performing: obtaining a plurality of sets of training data, wherein each set of the plurality of training data comprises a channel impulse response (CIR) and CIR-related data for a transmitting radio device, wherein the CIR-related data comprises at least one of a CIR phase, a CIR magnitude, value and index of a CIR magnitude peak, and mean value and standard deviation of CIR magnitude vector. Each set of the plurality of training data may further comprise a plurality of bounding box identifiers BBOX_ID, ID = 1, ..., N, each bounding box identifier corresponding to a radio device in a field of view of a computer vision (CV) system, and a label, indicating which radio device from the plurality of radio devices identified by the BBOX_ID corresponds to the transmitting radio device. Thereafter, the apparatus may further comprise means for training a trainable algorithm, in particular, a Random Forest Classifier (RFC) by combining an exhaustive search over RFC parameters values, to obtain, from the plurality of sets of training data, a best number of classification trees and a best maximum depth of the classification trees with respect to two corresponding metrics.

In some embodiment of the present invention, the trainable algorithm may be trained using supervised learning along with labelled data associated with the at least one radio device. In one example embodiment, the trainable algorithm may be validated using at least one of confusion matrix, precision, recall, F-measure, and/or classification accuracy.

In some embodiments of the present invention, the apparatus may be configured to obtain the plurality of sets of training data by sending a first message to the CV system, to instruct the CV system to start recording, the first message comprising a start time for the recording, sending a second message to a radio device, to request transmission of a radio signal frame from the radio device, the second message containing a configuration of the radio signal frame to be transmitted by the radio device, receiving, from the CV system, a video feed, the video feed identifying radio devices within a field of view of the CV system, and receiving, from the transmitting radio device, at least one radio signal frame, and storing for each received radio signal frame the CIR. It should be noted that the at least one radio signal frame may be received periodically from the transmitting radio device. The radio signal frame may also be referred to as a radio signal. Thereafter, the apparatus may be configured to send a notification to the CV system and the plurality of radio devices, in order to stop the ongoing procedure.

According to a third aspect of the invention, there is provided a method for identifying transmitting radio devices from a plurality of radio devices within a video feed. The method may comprise receiving, from the plurality of radio devices, at least one radio signal identifying a transmitting radio device, receiving, from a computer vision (CV) system, a video feed identifying radio devices within a field of view of the CV system, extracting a first set of features from the received at least one radio signal, extracting a second set of features from the received video feed, and providing the first set of features and the second set of features as an input to a machine learning (ML) algorithm to obtain a relationship between the transmitting radio device and the radio devices identified in the video feed.

In some embodiments of the present invention, the at least one radio signal may comprise a radio measurement, in particular a channel impulse response (CIR) of the transmitting radio device, the apparatus being configured to extract the first set of features by determining a phase and a magnitude of the CIR, and determining from the magnitude of the CIR, a peak position, and a peak value.

In some embodiments of the present invention, the method may further comprise extracting the second set of features by performing visual detection on the video feed, for example, using a mask region-based convolutional neural network, to determine a respective bounding box (BBOX) for each radio device in the video feed, each bounding box comprising an identifier (BBOX_ID).

It should be noted that without the use of the ML algorithm, correct identification of the transmitting radio device among the plurality of radio devices would not be feasible, and thus result in improper tracking or identification of the radio devices.

According to a fourth aspect of the present invention, there is provided a method for training a machine learning (ML) algorithm for determining a relationship between a transmitting radio device and radio devices identified in a video feed. The method may comprise obtaining a plurality of sets of training data, wherein each set of the plurality of training data comprises a channel impulse response (CIR) and CIR-related data for a transmitting radio device, wherein the CIR-related data comprises at least one of a CIR phase, a CIR magnitude, value and index of a CIR magnitude peak, and mean value and standard deviation of CIR magnitude vector. Each set of the plurality of training data may further comprise a plurality of bounding box identifiers BBOX_ID, ID = 1, ..., N, each bounding box identifier corresponding to a radio device in a field of view of a computer vision (CV) system, and a label, indicating which radio device from the plurality of radio devices identified by the BBOX_ID corresponds to the transmitting radio device. Thereafter, the method may comprise training a trainable algorithm, in particular, a Random Forest Classifier (RFC) by combining an exhaustive search over RFC parameters values, to obtain, from the plurality of sets of training data, a best number of classification trees and a best maximum depth of the classification trees with respect to two corresponding metrics.

In some embodiments of the present invention, the trainable algorithm may be trained using supervised learning along with labelled data associated with the at least one radio device. Preferably, the trainable algorithm may be validated using at least one of confusion matrix, precision, recall, F-measure, and/or classification accuracy. Such validation may assist in keeping a check on the accuracy of the trainable algorithm and thus, result in improving the identification and tracking of the transmitting radio device within the video feed.

According to a fifth aspect, there is provided a system for identifying transmitting radio devices from a plurality of radio devices within a video feed The system may comprise at least one radio access point, AP, a plurality of radio devices, and at least one computer vision (CV) system, wherein the at least one radio AP may be configured to receive, from the plurality of radio devices, at least one radio signal identifying a transmitting radio device, receiving, from the CV system, a video feed identifying radio devices within a field of view of the CV system, extracting a first set of features from the received at least one radio signal, extracting a second set of features from the received video feed, and providing the first set of features and the second set of features to a machine learning (ML) algorithm, to obtain a relationship between the transmitting radio device and the radio devices identified in the video feed.

According to a sixth aspect of the invention, there is provided a non-transitory computer-readable medium comprising instructions for causing a processor to perform functions including identifying transmitting radio devices from a plurality of radio devices within a video feed. The non-transitory computer-readable medium may comprise instructions for causing a processor to perform functions including receiving, from the plurality of radio devices, at least one radio signal identifying a transmitting radio device, receiving, from a computer vision (CV) system, a video feed identifying radio devices within a field of view of the CV system, extracting a first set of features from the received at least one radio signal, extracting a second set of features from the received video feed, and providing the first set of features and the second set of features as an input to a machine learning (ML) algorithm to obtain a relationship between the transmitting radio device and the radio devices identified in the video feed.

Altogether, the embodiments described herewith provides several advantages. In particular,
Allow identification of transmitting radio devices from a plurality of radio devices within a video feed, without the need of additional markers (such as signals or tags), which would require additional resources and have poor security.
Allow to assign radio signatures to visual instances of radio devices.
The obtained mapping between the radio domains and video feeds contributes to enhancing multi spectral, multi-sensory contextual navigation, as for example, implemented in the “MirrorWorld” concept through “Universal Maps”.
The obtained mapping between transmitting radio devices and visually identified radio devices may contribute to enhancing future mobility robustness optimization (MRO) and self-optimizing networks (SON). In particular, the disclosed embodiments may serve as a refinement/assistance technique for beam switching and/or mobility procedures, for example, in assistance to select radio device or user equipment (UE) panel, and in detection of areas in large industrial areas where line of sight (LOS) to one or multiple TRPs exist, even in the absence of detailed digital surface models.

To the accomplishment of the foregoing and related ends, one or more aspects comprise the features hereinafter fully described and particularly pointed out in the claims. The following description and the annexed drawings set forth in detail certain illustrative aspects and are indicative of but a few of the various ways in which the principles of the aspects may be employed. Other advantages and novel features will become apparent from the following detailed description when considered in conjunction with the drawings and the disclosed aspects are intended to include such aspects and their equivalents.

### BRIEF DESCRIPTION OF THE DRAWINGS

Further embodiments, details, advantages, and modifications of the present example embodiments will become apparent from the following detailed description of the embodiments, which is to be taken in conjunction with the accompanying drawings, wherein:

FIG. 1 illustrates a network cell diagram showing a system for identifying transmitting radio devices from a plurality of radio devices within a video feed, according to an example embodiment of the subject matter described herein.

FIG. 2 illustrates a block diagram showing a high level system architecture, according to an example embodiment of the subject matter described herein.

FIG. 3 illustrates a block diagram showing a detailed system architecture for identifying transmitting radio devices from a plurality of radio devices within a video feed, utilizing a machine learning (ML) algorithm, according to an example embodiment of the subject matter described herein.

FIG. 4 illustrates a block diagram showing a classifier input instance, according to an example embodiment of the subject matter described herein.

FIG. 5 illustrates a flowchart showing a method for identifying transmitting radio devices from a plurality of radio devices within a video feed, according to an example embodiment of the subject matter described herein.

FIG. 6 illustrates a block diagram showing a system architecture for a training phase, according to an example embodiment of the subject matter described herein.

FIG. 7 illustrates a flowchart showing a method for obtaining a plurality of sets of training data, according to an example embodiment of the subject matter described herein.

FIG. 8 illustrates a flowchart showing a method for training a trainable algorithm, in particular a random forest classifier (RFC), according to an example embodiment of the subject matter described herein.

FIG. 9 illustrates a block diagram showing a system architecture for identifying a transmitting radio device from a plurality of radio devices within a video feed, utilizing the trainable algorithm, in particular the RFC, during an implementation phase, according to another example embodiment of the subject matter described herein.

FIG. 10 illustrates a signaling diagram showing a method for obtaining a plurality of sets of training data, according to an example embodiment of the subject matter described herein.

FIGS. 11A and 11B illustrate graphs showing a comparison between an un-normalized confusion matrix and a normalized confusion matrix in terms of a true label and a predicted label, according to an example embodiment of the subject matter described herein.

FIGS. 12A and 12B illustrate graphs showing a comparison between an un-normalized confusion matrix and a normalized confusion matrix in terms of a true label and a predicted label, according to another example embodiment of the subject matter described herein.

FIGS. 13A and 13B illustrate graphs showing a comparison between an un-normalized confusion matrix and a normalized confusion matrix in terms of a true label and a predicted label, according to another example embodiment of the subject matter described herein.

FIG. 14 illustrate a block diagram showing one or more components of an apparatus, according to one example embodiment of the subject matter described herein.

### DETAILED DESCRIPTION

Some embodiments of this disclosure, illustrating its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to the listed item or items.

It should also be noted that as used herein and in the appended claims, the singular forms “a,” “an,” and “the” include plural references unless the context clearly dictates otherwise. Although any apparatus and method similar or equivalent to those described herein can be used in the practice or testing of embodiments of the present disclosure, the apparatus and methods are now described.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

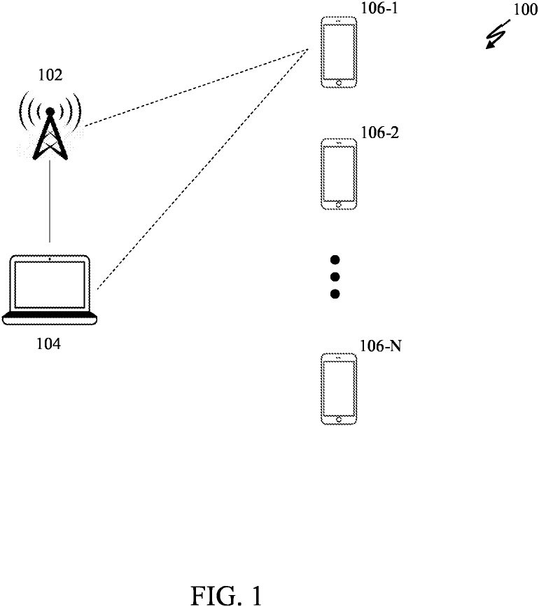

An example embodiment of the present disclosure and its potential advantages are understood by referring to FIGS. 1 through 14 of the drawings, like numerals being used for like and corresponding parts of the various drawings.

FIG. 1 illustrates a block diagram showing a system 100 for identifying transmitting radio devices from a plurality of radio devices within a video feed, according to an example embodiment. The system 100 may comprise at least one radio access point (AP) 102, a computer vision (CV) system 104, and a plurality of radio devices 106-1, ... 106-N. Hereinafter, the at least one radio access point (AP) 102 may be referred to as the radio AP 102. Hereinafter, the plurality of radio devices 106-1, ... 106-N may be referred to as 106. The plurality of radio devices 106 may include a first radio device 106-1, as second radio device 106-2, ... N^{th} radio device 106-N.

The radio AP 102 may be any networking hardware device that allows other wireless-enabled devices to connect to a wired network. Further, the radio AP 102 may be configured to identify transmitting radio device from the plurality of radio devices 106. It should be noted that the radio AP 102 may be used to determine the position or location of the plurality of radio devices 106 in an industrial private network. Examples of the radio AP 102 may include, but are not limited to, a mobile station (MS), an access terminal, a base station, a Universal Software Radio Peripheral (USRP), Wireless Fidelity (Wi-Fi) access point, eNodeB (eNB), or a radio station. It should be noted that above-mentioned examples of the radio AP 102 have been provided only for illustration purposes, without departing from the scope of the disclosure.

The CV system 104 may be configured to identify a transmitting radio device from the plurality of radio devices 106 within a field of view of the CV system 104. The field of view of the CV system 104 may be based on the hardware configuration (for example, aperture of cameras used, the number of cameras used, or other parameters) of the CV system 104. Further, the CV system 104 may be used to visually track the plurality of radio devices 106 in the industrial private network. It should be noted that visual tracking may be real-time in nature or may be periodic. In one example embodiment, the captured video feed may be stored in a server (not shown). In another example embodiment, the CV system 104 may comprise a memory (not shown) for storing the captured video feed. In one example embodiment, the CV system 104 may correspond to a laptop computer, as shown in FIG. 1. It should be noted that the CV system 104 may be a smart system capable of processing the captured video feed. In another example embodiment, the CV system 104 may be a passive system, relying on another system for the processing of the captured video feed. Examples of the CV system 104 may include, but are not limited to, an image capturing device like a webcam attached to a computer device, a video recording device, a camera, or personal digital assistants (PDA), or laptop computers.

Further, the CV system 104 may comprise input or output interfaces like a display screen, a touch screen, an antenna, and/or a microphone. In one example embodiment, the touch screen may correspond to at least one of a resistive touch screen, capacitive touch screen, or a thermal touch screen. It should be noted that above-mentioned examples of the CV system 104 have been provided only for illustration purposes, without departing from the scope of the disclosure.

Each one of the plurality of radio devices 106 may comprise at least one transceiver, for communication purposes. In one example embodiment, a confidence level of the plurality of radio devices 106, within the field of view of the CV system 104 may be determined. In one example embodiment, the plurality of radio devices 106 corresponds to a smartphone, as shown in FIG. 1. It should be noted that the radio devices 106 may be of different types and examples of plurality of radio devices 106 may include, but are not limited to, user equipment (UE), operator owned devices like a robot, a machine like a computer, a telephone, a desktop, a personal digital assistant (PDA), a handheld radio device, or a laptop computer. Further, each one of the plurality of radio devices 106 may comprise input or output interfaces like a display screen, a touch screen, an antenna, and/or a microphone. In one example embodiment, the touch screen may correspond to at least one of a resistive touch screen, capacitive touch screen, or a thermal touch screen. It will be apparent to one skilled in the art that the above-mentioned examples of the plurality of radio devices 106 have been provided only for illustration purposes, without departing from the scope of the disclosure.

Further, each one of the plurality of radio devices 106 may communicate with the radio AP 102 and the CV system 104 via a communication network (not shown). The communication network may be implemented using at least one communication technique selected from and not limiting to Visible Light Communication (VLC), Worldwide Interoperability for Microwave Access (WiMAX), Long term evolution (LTE), Wireless local area network (WLAN), Infrared (IR) communication, Public Switched Telephone Network (PSTN), Radio waves, and any other wired and/or wireless communication techniques.

It will be apparent to one skilled in the art that the above-mentioned components of the system 100 have been provided only for illustration purposes. In one example embodiment, the system 100 may comprise a plurality of radio APs and a plurality of CV systems as well, without departing from the scope of the disclosure.

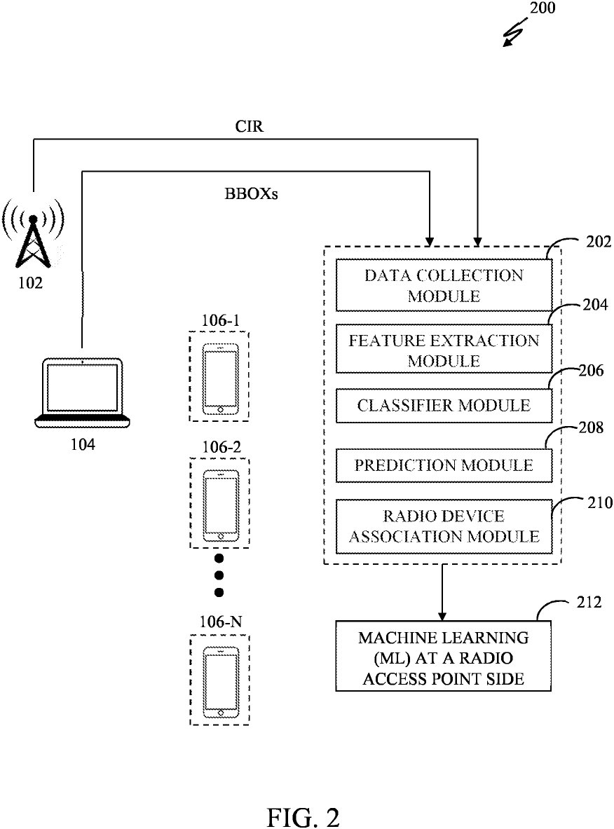

FIG. 2 illustrates a block diagram showing a high level system architecture 200, according to an example embodiment. Referring to FIG. 2, the system architecture 200 may include the radio AP 102, the CV system 104, and the plurality of radio devices 106. Further, the system architecture 200 may include a data collection module 202, a feature extraction module 204, a classifier module 206, a prediction module 208, and a radio device association module 210. It should be noted that the radio device association module 210 may also be referred to as user equipment (UE) association module 210.

At first, a communication interface may be established between the radio AP 102 and the CV system 104. It should be noted that a handshake procedure may be performed for establishing the communication interface and exchanging functioning parameters between the radio AP 102 and the CV system 104. Successively, the data collection module 202 may receive at least one radio signal identifying a transmitting radio device from the plurality of radio devices 106. In one example embodiment, the transmitting radio device may be one of the plurality of radio devices 106. Hereinafter, the radio signal and radio signal frame may be used interchangeably. In one example embodiment, the at least one radio signal may comprise a radio measurement, in particular a channel impulse response (CIR) of the transmitting radio device. Further, the data collection module 202 may receive a video feed identifying radio devices 106 within a field of view of the CV system 104. It should be noted that the radio devices 106 may be identified in the video feed by an identifier. In one example embodiment, the first radio device may be represented by 106-1, the second radio device by 106-2, ... the N^{th} radio device by 106-N, as shown in FIG. 2.

Successively, the received at least one radio signal and the video feed may be fed to the feature extraction module 204. The feature extraction module 204 may extract a first set of features from the received at least one radio signal. The first set of features may be extracted by determining a phase of the CIR and a magnitude of the CIR. Further, a peak position and a peak value may be determined from the magnitude of the CIR. Further, the feature extraction module 204 may extract a second set of features from the received video feed. The second set of features may be extracted by performing visual detection on the video feed, preferably using a mask region-based convolutional neural network, to determine a respective bounding box (BBOX) (shown by a dotted box in FIG. 2) for each radio device 106 in the video feed. It should be noted that each bounding box may comprise an identifier (BBOX_ID).

The extracted first set of features and the second set of features may be provided as an input to the classifier module 206. The classifier module 206 may be configured to obtain a relationship between the transmitting radio device and the radio devices 106 identified in the video feed, utilizing a machine learning (ML) algorithm. In one example embodiment, the ML algorithm may be implemented using a random forest classifier (RFC), having a plurality of classification trees. Each classification tree may be configured to process a subset of the first set of features and a subset of the second set of features. In one example embodiment, the RFC may be configured to provide an output, as a Boolean value, indicative of whether the transmitting radio device is identified in the video feed. In another example embodiment, the RFC may be configured to output a probability distribution over the BBOXs in the video feed, indicating the probability of the transmitting radio device being one of the radio devices 106 identified in the BBOXs.

Successively, the output of the classifier module 206 may be used for the prediction module 208, for stating RFC prediction. It should be noted that the prediction module 208 may also be referred to as a RFC output module. In one example embodiment, for N classification trees, N predictions may be used to establish the RFC prediction. Thereafter, the radio device association module 210 may be configured to provide an association or a relationship between the transmitting radio device and the radio devices 106 identified in the video feed, based at least on the prediction provided by the prediction module 208. Such identification of the transmitting radio devices from the plurality of radio devices 106 within the video feed, without the use of additional markers (for example, signal, tag, etc.), may result in improving security and eliminating the additional efforts required to manage the additional markers.

It should be noted that the ML algorithm for radio device 106 recognition may be implemented at the radio AP 102 i.e. ML at a radio AP side (shown by 212). In another example embodiment, the ML algorithm for radio device 106 recognition may be implemented at the CV system 104 as well, without departing from the scope of the disclosure.

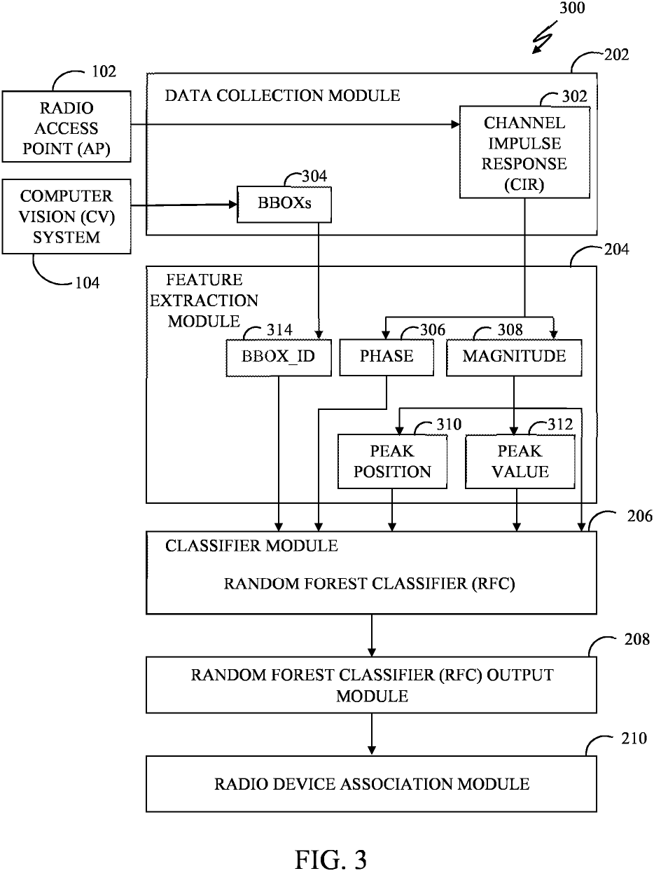

FIG. 3 illustrates a block diagram showing a detailed system architecture 300 for identifying transmitting radio devices from the plurality of radio devices 106 within the video feed, utilizing the ML algorithm, according to an example embodiment. FIG. 3 is described in conjunction with FIG. 2.

As discussed above, a communication interface may be established between the radio AP 102 and the CV system 104. It should be noted that the handshake procedure may be performed for establishing the communication interface and exchanging functioning parameters between the radio AP 102 and the CV system 104. Referring to FIG. 3, the data collection module 202 may receive at least one radio signal identifying a transmitting radio device, from the plurality of radio devices 106. In one example embodiment, the at least one radio signal may comprise a radio measurement, in particular a channel impulse response (CIR) (shown by 302) of the transmitting radio device, as shown in FIG. 3. It should be noted that the radio signal frames may be received from a singular transmitting radio device. Further, the data collection module 202 may receive the video feed identifying radio devices 106 within a field of view of the CV system 104. In one example embodiment, the video feed may be received from the CV system 104. In one example embodiment, the radio devices 106 may be identified in the video feed by an identifier. Further, the video feed may comprise information related to BBOXs (shown by 304) associated with each of the plurality of radio devices 106, within the field of view of the CV system 104. It should be noted that the positions may be varied through space for the plurality of radio devices 106.

It should be noted that the data collected from the video feed and the at least one radio signal may be acquired concurrently with different periodicity. In one example embodiment, timestamps may be used, as unique identifiers, to match the data collected from the video feed and the radio signal and generate a unified structure with CIRs (shown by 302) and BBOXs (shown by 304). Successively, the received at least one radio signal and the video feed may be fed to the feature extraction module 204. The feature extraction module 204 may extract a first set of features from the received at least one radio signal. The first set of features may be extracted by determining a phase of the CIR (shown by 306) and a magnitude of the CIR (shown by 308). Further, the magnitude of the CIR may be used to determine a peak position (shown by 310) and a peak value (shown by 312). In one example embodiment, timestamp information is associated with the extracted first set of features.

Further, the feature extraction module 204 may extract a second set of features from the received video feed. The second set of features may be extracted by performing visual detection on the video feed, to determine a respective bounding box, BBOX, for each radio device 106 in the video feed. It should be noted that each bounding box may comprise an identifier, BBOX_ID (shown by 314). In one example embodiment, timestamp information is associated with the extracted second set of features. In one example embodiment, the visual detection may be performed by fine-tuning a mask region-based convolutional neural network (R-CNN) available in Detectron2 framework, for determining a respective bounding box, BBOX, for each radio device 106 in the video feed. It should be noted that Detectron2 is a FACEBOOK™ artificial intelligence research (FAIR)′s next generation software system that implements state-of-the-art object detection algorithms.

In one example embodiment, a Universal Software Radio Peripheral (USRP) segmentation model may be trained from the R101-FPN Mask R-CNN model pre-trained on Common Objects in Context (COCO) dataset, available in Detectron2′s. It will be apparent to one skilled in the art that the above-mentioned Detectron2 framework has been provided only for illustration purposes. In one example embodiment, some other framework can be used for the visual detection, without departing from the scope of the disclosure.

In one example embodiment, radio signals and a video feed may be periodically received. The radio signals may be received with a first frequency, and the video feed may be received with a second frequency. In particular, the first frequency may be higher than the second frequency, meaning that radio signals are received more often than video feeds. Each reception is timestamped, as shown in Table 1 for radio signals, respectively in Table 2 for the video feed. For the radio signals, the CIR value for each instance is associated with the timestamp of that instance. For example, CIR 1 at a TIMESTAMP 1, CIR 2 at a TIMESTAMP 2, and so on.

TABLE 1

RADIO

| | |
|---|---|
| TIMESTAMP 1 | CIR 1 |
| TIMESTAMP 2 | CIR 2 |
| TIMESTAMP 3 | CIR 3 |
| TIMESTAMP 4 | CIR 4 |
| ... | ... |
| TIMESTAMP N | CIR N |
| TIMESTAMP N+1 | CIR N+1 |
| TIMESTAMP N+2 | CIR N+2 |
| TIMESTAMP N+3 | CIR N+3 |

It should be noted that the second set of features are associated to timestamp information corresponding to each BBOX extracted from the video feed.

TABLE 2

VIDEO

| | |
|---|---|
| TIMESTAMP 1 | BB |

It should be noted that the first period may be lower than the second period. Successively, the radio signals received during the second period, may be averaged to obtain an averaged radio signal. Such averaging of the radio measurements results in reducing the complexity and eliminating the problems related to synchronization. Thereafter, the first set of features extracted from the averaged radio signal with the second set of features extracted from the video feed, may be merged, using timestamps, to obtain the input to the ML algorithm. Alternatively, it should be noted that the frequency of acquisition of the radio frames may be higher than the frequency of the acquisition of the video frames. Further, the radio measurements may be averaged for a period corresponding to one video measurement. Thereafter, the two sets of features may be merged using timestamps, which may be easily provided by the radio AP 102 and the CV system 104.

Successively, the ML algorithm may be implemented using a random forest classifier (RFC). It should be noted that the RFC may be an ensemble learning algorithm that uses a plurality of classification trees. Each classification tree may be configured to process a subset of the first set of features and the second set of features. In one example embodiment, N classification trees are used for stating N predictions which in turn used for establishing RFC predictions. Successively, the RFC may be configured to output a Boolean value indicative of whether the transmitting radio device is identified in the video feed. Successively, the output of the RFC may be used for the RFC output module 208, for stating RFC prediction. Thereafter, the radio device association module 210 may be configured to provide an association or a relationship between the transmitting radio device and the radio devices 106 identified in the video feed.

It will be apparent to one skilled in the art that the above-mentioned RFC has been provided only for illustration purposes. In one example embodiment, a neural network may also be used, without departing from the scope of the disclosure.

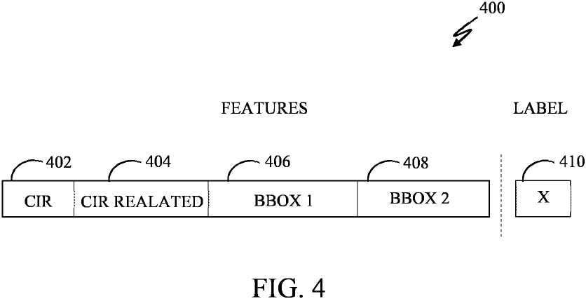

FIG. 4 illustrates a block diagram showing a classifier input instance 400, according to an example embodiment.

The classifier input instance 400 may include a channel impulse response CIR (shown by 402) and CIR-related data (shown by 404) for a transmitting radio device. The CIR-related data (shown by 404) may include at least one of a CIR phase, a CIR magnitude, value and index of a CIR magnitude peak, mean value of CIR magnitude vector, and standard deviation of CIR magnitude vector. Further, the classifier input instance 400 may include a plurality of bounding box identifiers BBOX_ID, ID = 1, ..., N. It should be noted that each bounding box identifier may correspond to a radio device 106 in a field of view of the CV system 104. For example, BBOX 1 (shown by 406) may correspond to the radio device 106-1 and BBOX 2 (shown by 408) may correspond to the radio device 106-2. Further, a label (shown by 410) may indicate which radio device 106 from the plurality of radio devices 106, identified by the BBOX_ID, corresponds to the transmitting radio device. In one example embodiment, for example, for two radio devices 106-1 and 106-2 in the training, the label X may have a value 0, 1, or 2, where X=0 represents that no radio device 106 is transmitting, X=1 means that the radio device 106-1 associated with BBOX 1 is transmitting, and X=2 means that the radio device 106-2 associated with BBOX 2 is transmitting. It should be noted that the above-mentioned example has been provided only for illustration purposes, without departing from the scope of the disclosure.

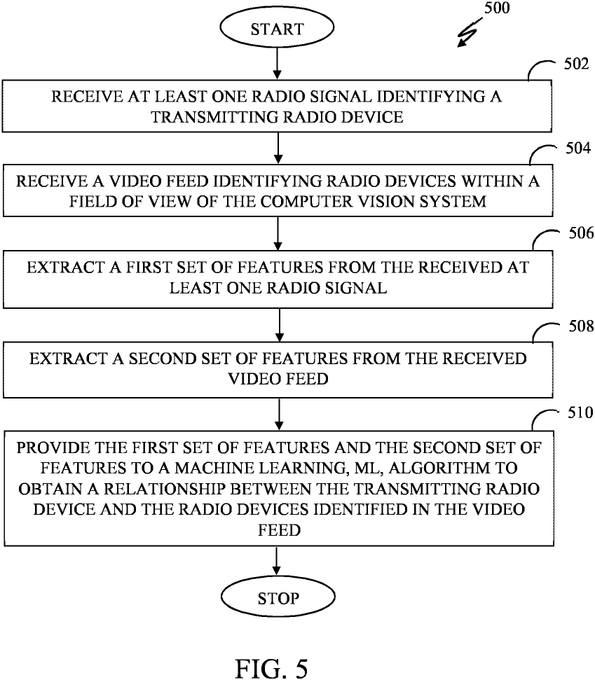

FIG. 5 illustrates a flowchart 500 showing a method for identifying transmitting radio devices from a plurality of radio devices 106 within a video feed, according to an example embodiment. FIG. 5 is described in conjunction with FIGS. 2, 3, and 4.

At first, at least one radio signal identifying a transmitting radio device may be received, at step 502. In one example embodiment, the radio AP 102 may receive the at least one radio signal identifying a transmitting radio device, from the plurality of radio devices 106. The at least one radio signal may comprise a radio measurement, in particular a channel impulse response (CIR) of the transmitting radio device. Successively, a video feed identifying radio devices 106 within a field of view of the CV system 104 may be received, at step 504. In one example embodiment, the radio AP 102 may receive the video feed identifying the radio devices 106 within a field of view of the CV system 104, from the CV system 104. It should be noted that the radio devices 106 in the video feed, may be identified by an identifier. Further, data collected from the video feed may contain information related to BBOXs associated with each of the plurality of radio devices 106, within the field of view of the CV system 104. It should be noted that the collected data from the video feed and the at least one radio signal may be received concurrently with different periodicity.

Successively, a first set of features may be extracted from the received at least one radio signal, at step 506. In one example embodiment, the radio AP 102 may extract the first set of features from the received at least one radio signal. The first set of features may be extracted by determining a phase of the CIR and a magnitude of the CIR. Further, the magnitude of the CIR may be used to determine a peak position and a peak value. In one example embodiment, timestamp information is associated with the extracted first set of features. Successively, a second set of features may be extracted from the received video feed, at step 508. In one example embodiment, the radio AP 102 may extract the second set of features from the received video feed. The second set of features may be extracted by performing visual detection on the video feed, to determine a respective bounding box (BBOX) for each radio device 106 in the video feed. It should be noted that each bounding box may comprise an identifier (BBOX_ID). In one example embodiment, timestamp information is associated with the extracted second set of features.

In one example embodiment, the visual detection may be performed by fine-tuning a mask region-based convolutional neural network (R-CNN) available in Detectron2 framework, for determining a respective bounding box, BBOX, for each radio device 106 in the video feed. It should be noted that Detectron2 is a FACEBOOK™ artificial intelligence research (FAIR)′s next generation software system that implements state-of-the-art object detection algorithms. In one example embodiment, a Universal Software Radio Peripheral (USRP) segmentation model may be trained from the R101-FPN Mask R-CNN model pre-trained on Common Objects in Context (COCO) dataset, available in Detectron2′s. It will be apparent to one skilled in the art that the above-mentioned Detectron2 framework has been provided only for illustration purposes. In one example embodiment, some other framework can be used for the visual detection, without departing from the scope of the disclosure.

In one example embodiment, the radio AP 102 may periodically receive radio signals and the video feed. The radio signals may be received with a first frequency and the video feed may being received with a second frequency during a reception period. In particular the first frequency may be higher than the second frequency. The radio AP 102 may average the radio signals received during the reception period to obtain an averaged radio signal. Thereafter, the radio AP 102 may merge the first set of features extracted from the averaged radio signal with the second set of features extracted from the video feed, using timestamps, to obtain the input to a machine learning (ML) algorithm.

Thereafter, the first set of features and the second set of features may be provided as an input to the ML algorithm, to obtain a relationship between the transmitting radio device and the radio devices 106 identified in the video feed, at step 510. The ML algorithm may be implemented using a random forest classifier, RFC, having a plurality of classification trees. Each classification tree being configured to process a subset of the first set of features and the second set of features. In one example embodiment, the RFC may be configured to output a Boolean value indicative of whether the transmitting radio device is identified in the video feed. In another example embodiment, the RFC may be configured to output a probability distribution over the bounding boxes (BBOX) in the video feed, indicating the probability of the transmitting radio device being one of the radio devices 106 identified in the BBOXs. For example, transmitting radio devices are {UEI, UE2, UE3} and video feed is {A, B}, then a probability i.e. p(UE1 = A) may be equal to 90% while the probability i.e. p(UE2 = B) may be equal to 10%.

Such usage of the machine learning (ML) algorithm for obtaining a relationship between the transmitting radio device and the radio devices 106 identified in the video feed, contributes in achieving “Universal Maps”, the multi spectral, multi-sensory contextual navigation of “MirrorWorld”. Further, such identification of the transmitting radio device from the plurality of radio device 106 within the video feed, without the use of additional markers (i.e. signal, tag, etc.), may result in eliminating the additional efforts required to manage the additional markers. Additionally, the identification of the radio device 106 using the disclosed method provides improved security. It will be apparent to one skilled in the art that the above-mentioned RFC has been provided only for illustration purposes. In one example embodiment, some other classifier having machine learning capabilities can also be used, without departing from the scope of the disclosure.

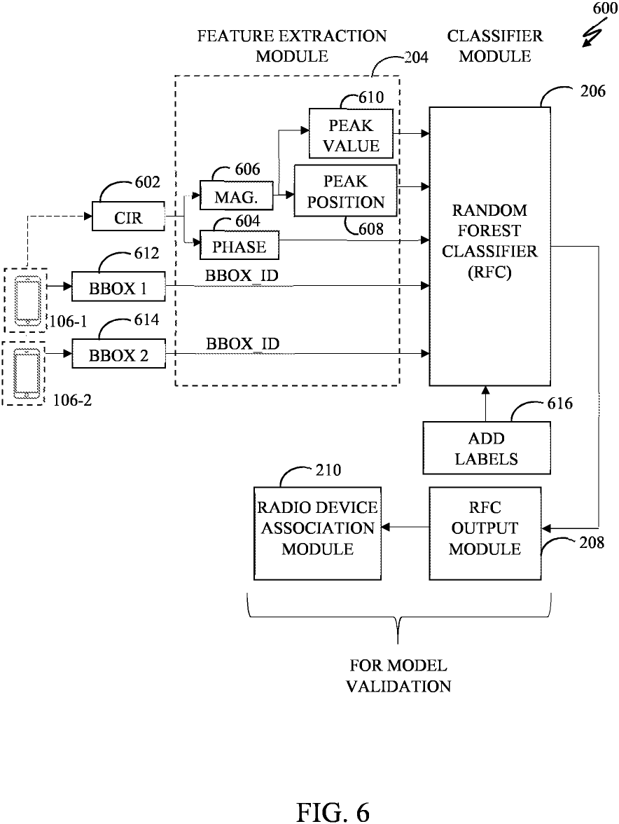

FIG. 6 illustrates a system architecture 600 for training phase, according to an example embodiment. FIG. 6 is described in conjunction with FIGS. 2, 3, 4, and 5. The system architecture 600 may comprise a first radio device 106-1 and a second radio device 106-2.

At first, the radio AP 102 may receive a radio signal, in particular channel impulse response (CIR) (shown by 602) from the first radio device 106-1. Further, the first radio device 106-1 and the second radio device 106-2 may be identified in the video feed by the CV system 104. Successively, the received radio signal and the video feed may be fed to the feature extraction module 204. The feature extraction module 204 may extract a first set of features from the received at least one radio signal. The first set of features may be extracted by determining a phase of the CIR (shown by 604) and a magnitude of the CIR (shown by 606). Further, the magnitude of the CIR (shown by 606) may be used to determine a peak position (shown by 608) and a peak value (shown by 610). Further, the feature extraction module 204 may extract a second set of features from the received video feed.

As discussed above, the second set of features may be extracted by performing visual detection on the video feed, to determine a respective bounding box, BBOX, for each radio device 106 in the video feed. It should be noted that each bounding box comprising an identifier, BBOX_ID, shown in FIG. 6. For example, BBOX 1 (shown by 612) may correspond to the first radio device 106-1 and BBOX 2 (shown by 614) may correspond to the second radio device 106-2. Each bounding box i.e. BBOX 1 (shown by 612) and BBOX 2 (shown by 614) may comprise an identifier, BBOX_ID. As discussed above, the visual detection may be performed by fine-tuning a mask region-based convolutional neural network (R-CNN) available in Detectron2 framework, for determining a respective bounding box, BBOX, for each radio device 106 in the video feed.

Successively, the extracted first set of features and the second set of features, may be provided as input to the classifier module 206. In one example embodiment, the classifier module 206 may have the RFC that may be trained for identification of transmitting radio devices from the plurality of radio devices 106. It should be noted that the training of the RFC may be performed at the radio AP 102. In one example embodiment, the radio AP 102 may obtain a plurality of sets of training data. The plurality of sets of training data may be obtained by sending a first message to the CV system 104, to instruct the CV system 104 to start recording. It should be noted that the first message may comprise a start time for the recording. Successively, a second message may be sent to the radio device 106 to request transmission of a radio signal frame from the radio device 106. It should be noted that the second message may contain a configuration of the radio signal frame to be transmitted by the radio device 106. Successively, a video feed identifying radio devices 106 within a field of view of the CV system 104, may be received from the CV system 104. Thereafter, at least one radio signal frame may be received from a transmitting radio device. In one example embodiment, the radio AP 102 may determine and store for each received radio signal frame a channel impulse response, CIR.

In one example embodiment, each set of the plurality of training data may comprise the CIR and CIR related data for a transmitting radio device. In one example embodiment, the transmitting radio device may correspond to the first radio device 106-1. The CIR-related data may comprise at least one of a CIR phase, a CIR magnitude, value and index of a CIR magnitude peak, and mean value and standard deviation of CIR magnitude vector. Further, each set of the plurality of training data may comprise a plurality of bounding box identifiers BBOX_ID, ID = 1, ..., N. Each bounding box identifier may correspond to a radio device 106 identified within the field of view of the CV system 104. Further, each set of the plurality of training data may comprise a label (shown by 616), indicating which radio device 106 from the plurality of radio devices 106 identified by the BBOX_ID corresponds to the transmitting radio device. It should be noted that during the training phase, the RFC with the label (shown by 616) may provide correct transmitting radio device and accurate identification of relationship between the transmitting radio device and the radio devices 106 identified in the video feed.

Successively, a trainable algorithm, in particular the RFC may be trained by combining an exhaustive search over RFC parameter values, to obtain, from the plurality of sets of training data, a best number of classification trees and a best maximum depth of the classification trees with respect to two corresponding metrics. In one example embodiment, the trainable algorithm may be trained using supervised learning along with labelled data associated with the at least one radio device 106. Successively, the RFC may be configured to output a Boolean value indicative of whether the transmitting radio device is identified in the video feed. In one example embodiment, the output of the RFC prediction may be decisional i.e. of type “0” or “1” for the transmitting radio device. In another example embodiment, the RFC may be configured to output a probability distribution over the BBOXs in the video feed, indicating the probability of the transmitting radio device being one of the radio devices 106 identified in the BBOXs.

Successively, the output of the RFC may be used for the RFC output module 208, for stating RFC prediction. In one example embodiment, for N classification trees, N predictions may be used to establish the RFC prediction. Thereafter, the radio device association module 210 may be configured to provide an association between the transmitting radio device and the radio devices 106 identified in the video feed, using the trainable algorithm. It should be noted that the RFC output module 208 and the radio device association module 210, may be jointly used for the validation of the trainable algorithm.

In one example embodiment, the trainable algorithm may be validated using at least one of confusion matrix, precision, recall, F-measure, and/or classification accuracy. In one example embodiment, the training data may represent 80% of total amount of the data and the validation may represent 20%. In one example embodiment, the training phase may use 10- fold cross-validation procedure. Further, two different metrics may be used for evaluation in each iteration, the logarithmic loss, and the F1 score. It should be noted that the best model may be selected and used for model validation, computation of the confusion matrix, precision, recall, F1 score and classification accuracy. In one example embodiment, the confusion matrix i.e. error matrix, may be a specific table layout that allows visualization of the performance of an algorithm, typically a supervised learning model. Further, each row of the matrix may represent the instances in a predicted class while each column represents the instances in an actual class (or vice versa). It should be noted that names make it easy to check whether a system is confusing two classes or mis-labelling one class as another.

In one example embodiment, the precision may correspond to the ability of the classifier not to label as positive a sample that is negative. In one example embodiment, the recall may represent the ability of the classifier to find all the positive samples. In one example embodiment, F-measure (Fβ and F1) may be interpreted as a weighted harmonic mean of the precision and recall. It should be noted that a Fβ measure reaches its best value at 1 and its worst score at 0. In one example embodiment, with β=1, Fβ and F1 are equivalent. It should be noted that the validation of the trainable algorithm may assist in keeping a check on the accuracy of the trainable algorithm i.e. RFC, and thus results in improving tracking of the transmitting radio device. Without the use of the trainable algorithm, the identification of the transmitting radio devices from the plurality of radio devices 106 within the video feed would not be feasible.

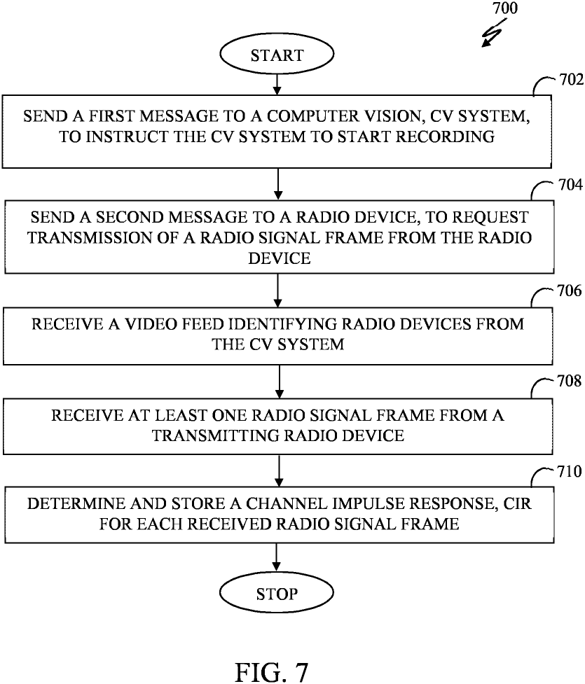

FIG. 7 illustrates a flowchart 700 showing a method for obtaining a plurality of sets of training data, according to an example embodiment. FIG. 7 is described in conjunction with FIGS. 2, 3, 4, 5, and 6.

At first, the radio AP 102 may trigger a data collection procedure by sending dedicated signaling and custom-built information elements. Successively, a first message may be sent to the CV system 104, to instruct the CV system 104 to start recording, at step 702. In one example embodiment, the radio AP 102 may send the first message to the CV system 104, to instruct the CV system 104 to start recording. It should be noted that the first message may comprise a start time for the recording. Successively, a second message may be sent to a radio device 106 to request transmission of a radio signal frame from the radio device 106, at step 704. In one example embodiment, the radio AP 102 may send the second message to the radio device 106 to request transmission of the radio signal frame from the radio device 106. The radio signal frame may be referred to as a radio signal or a frame. It should be noted that the second message may contain a configuration of the radio signal frame to be transmitted by the radio device 106. Successively, a video feed identifying radio devices 106 within a field of view of the CV system 104, may be received, at step 706. In one example embodiment, the radio AP 102 may receive the video feed identifying radio devices 106 within a field of view of the CV system 104, from the CV system 104.

Successively, at least one radio signal frame may be received from the transmitting radio device, at step 708. In one example embodiment, the radio AP 102 may receive the at least one radio signal frame from the transmitting radio device. Successively, the radio AP 102 may determine and store a channel impulse response, CRI, for each received radio signal frame, at step 710. Thereafter, the radio AP 102 may send a stop notification to the CV system 104 and the radio devices 106, to stop the ongoing procedure.

In one example embodiment, the data collection procedure may be triggered in one or more non-exhaustive scenarios such as when a new radio device is added to the system 100. It should be noted that the radio AP 102 may be aware of the radio device type and may store the data gathered for each type of radio devices 106. In another example embodiment, the data collection procedure may be triggered when a change in the industrial environment is observed, and then the video domain and the radio domain may be changed. The change in the video domain and the radio domain may be signaled to the radio AP 102 though a notification sent from the CV system 104. In another example embodiment, the data collection procedure may be triggered when a change in radio transmission that may affect the CIR, is performed. It should be noted that triggering of the data collection procedure has been provided only for illustration purposes. In one example embodiment, some other non-exhaustive scenarios for triggering the data collection procedure may also be used, without departing from the scope of the disclosure.

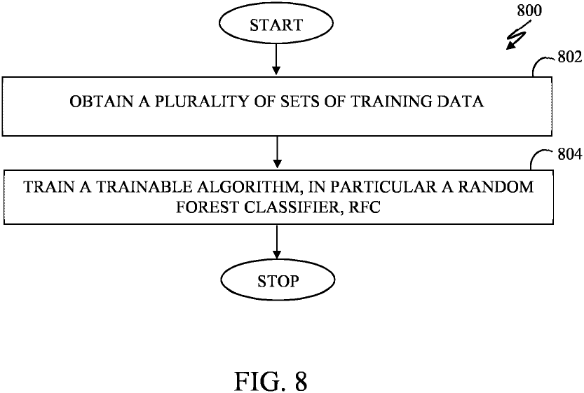

FIG. 8 illustrates a flowchart 800 showing a method for training a trainable algorithm, in particular a random forest classifier (RFC), according to an example embodiment. FIG. 8 is described in conjunction with FIGS. 2, 3, 4, 5, 6, and 7.

At first, a plurality of sets of training data may be obtained, at step 802. In one example embodiment, the radio AP 102 may obtain the plurality of sets of training data. As discussed above, the data collection procedure may be triggered for obtaining the plurality of sets of training data. Each set of the plurality of training data may comprise the CIR and CIR related data for a transmitting radio device. The CIR-related data may comprise at least one of a CIR phase, a CIR magnitude, value and index of a CIR magnitude peak, and mean value and standard deviation of CIR magnitude vector. Further, each set of the plurality of training data may comprise a plurality of bounding box identifiers BBOX_ID, ID = 1, ..., N. Each bounding box identifier may correspond to a radio device 106 identified within a field of view of the CV system 104. Further, each set of the plurality of training data may comprise a label, indicating which radio device 106 from the plurality of radio devices 106 identified by the BBOX_ID corresponds to the transmitting radio device. It should be noted that during the training phase, the RFC with the label may provide correct transmitting radio device and accurate identification of relationship between the transmitting radio device and the radio devices 106 identified in the video feed.

Successively, a trainable algorithm, in particular the RFC may be trained, at step 804. In one example embodiment, the radio AP 102 may train the trainable algorithm by combining an exhaustive search over RFC parameter values, to obtain, from the plurality of sets of training data, a best number of classification trees and a best maximum depth of the classification trees with respect to two corresponding metrics. In one example embodiment, the trainable algorithm may be trained using supervised learning along with labelled data associated with the at least one radio device. It will be apparent to one skilled in the art that the above-mentioned method for training the trainable algorithm has been provided only for illustration purposes, without departing from the scope of the disclosure.

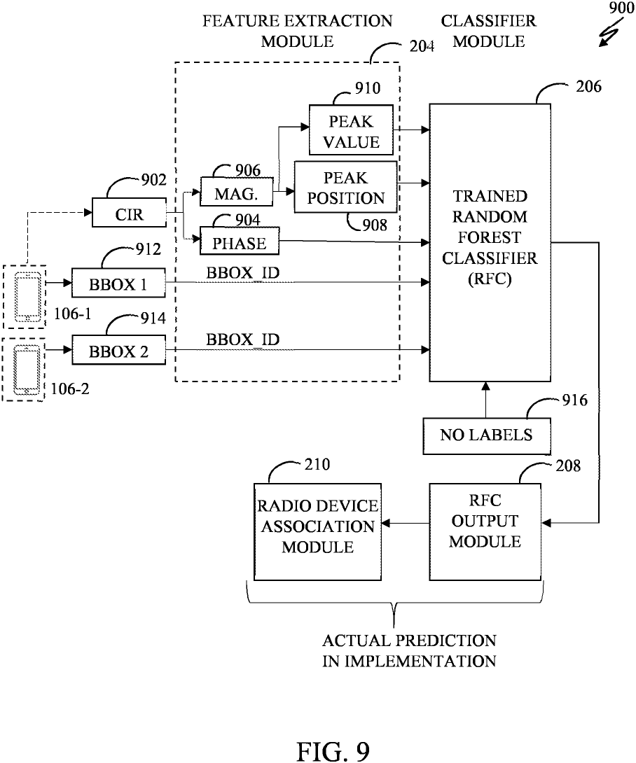

FIG. 9 illustrates a block diagram showing a system architecture 900 for identifying a transmitting radio device from the plurality of radio devices 106 within a video feed, utilizing the trainable algorithm, in particular the RFC, during an implementation phase, according to an example embodiment. FIG. 9 is described in conjunction with FIGS. 2, 3, 4, 5, 6, 7, and 8. It should be noted that the trained RFC may be fed to the CV system 104 during the implementation phase or at the deployment of the system on a dedicated interface, for identifying a transmitting radio device.

At first, the radio AP 102 may receive a radio signal, in particular channel impulse response (CIR) (shown by 902) from the first radio device 106-1. Further, the first radio device 106-1 and the second radio device 106-2 may be identified in the video feed by the CV system 104. Successively, the received radio signal and the video feed may be fed to the feature extraction module 204. The feature extraction module 204 may extract a first set of features from the received at least one radio signal. The first set of features may be extracted by determining a phase of the CIR (shown by 904) and a magnitude of the CIR (shown by 906). Further, the magnitude of the CIR (shown by 906) may be used to determine a peak position (shown by 908) and a peak value (shown by 910). Further, the feature extraction module 204 may extract a second set of features from the received video feed.

As discussed above, the second set of features may be extracted by performing visual detection on the video feed, to determine a respective bounding box, BBOX, for each radio device 106 in the video feed. It should be noted that each bounding box comprising an identifier, BBOX_ID, shown in FIG. 6. For example, BBOX 1 (shown by 912) may correspond to the first radio device 106-1 and BBOX 2 (shown by 914) may correspond to the second radio device 106-2. Each bounding box i.e. BBOX 1 (shown by 912) and BBOX 2 (shown by 914) may comprise an identifier, BBOX_ID. As discussed above, the visual detection may be performed by fine-tuning a mask region-based convolutional neural network (R-CNN) available in Detectron2 framework, for determining a respective bounding box, BBOX, for each radio device 106 in the video feed.

Successively, the extracted first set of features and the second set of features, may be provided as input to the classifier module 206. In the implementation phase, the classifier module 206 may include the trained RFC for identifying a transmitting radio device. In one example embodiment, the transmitting radio device may be one of the plurality of radio devices 106. Further, no labels (shown by 916) may be required as an input to the trained RFC, during the implementation phase. As discussed above, the RFC may be trained by combining an exhaustive search over RFC parameter values, to obtain, from the plurality of sets of training data, a best number of classification trees and a best maximum depth of the classification trees with respect to two corresponding metrics. In one example embodiment, the trainable algorithm may be trained using supervised learning along with labelled data associated with the at least one radio device 106.

Successively, the RFC may be configured to output a Boolean value indicative of whether the transmitting radio device is identified in the video feed. In one example embodiment, the output of the RFC prediction may be decisional i.e. of type “0” or “1” for the transmitting radio device. In another example embodiment, the RFC may be configured to output a probability distribution over the BBOXs in the video feed, indicating the probability of the transmitting radio device being one of the radio devices 106 identified in the BBOXs. Successively, the output of the RFC may be used for the RFC output module 208, for stating RFC prediction. Thereafter, the radio device association module 210 may be configured to provide an association between the transmitting radio device and the radio devices 106 identified in the video feed. It should be noted that the RFC output module 208 and the radio device association module 210, may be jointly used for providing actual prediction implementation, without departing from the scope of the disclosure.

Such actual prediction assists in providing information related to a relationship between the transmitting radio device and the radio devices 106 identified in the video feed. Additionally, actual prediction implementation may result in accurate tracking and positioning of transmitting radio devices 106 in an industry environment. Thus, such disclosed method and system solves the problem of identifying and matching a device in both the radio domain and the computer vision domain through means of learning i.e. machine learning.

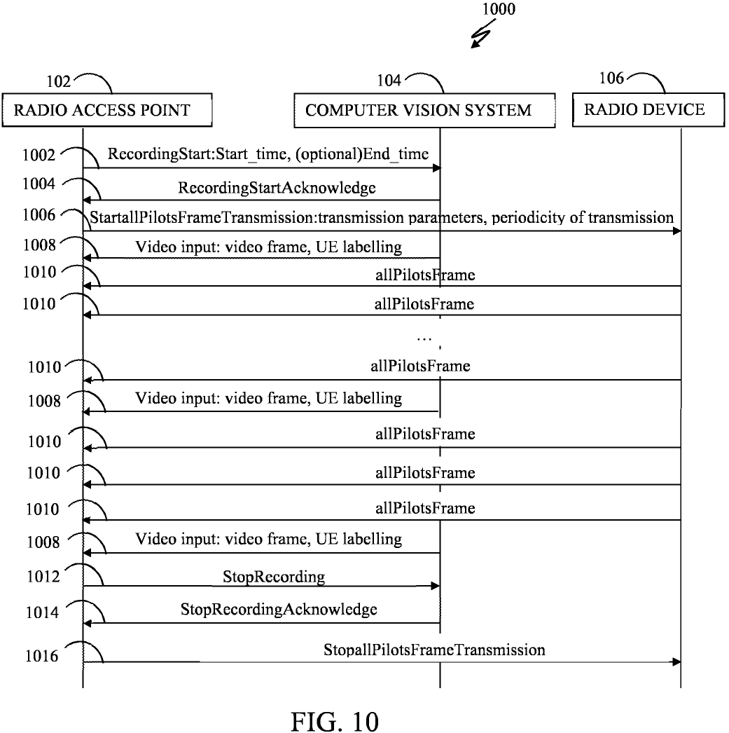

FIG. 10 illustrates a signaling diagram 1000 showing a method for collecting a plurality of sets of training data, according to an example embodiment.

At first, the radio AP 102 may send a first message i.e. RecordingStart notification message to the CV system 104, at step 1002. It should be noted that the RecordingStart notification message may be sent through a dedicated communication interface. In one example embodiment, the RecordingStart notification message may include an information element (IE) with information for the start time and end time of the recording. In one example embodiment, the RecordingStart notification message may include the format in which the labels of the video feed are communicated. In one case, if the CV system 104 is not dummy, then the visual recognition of the radio device 106 may be performed. In one example embodiment, the video feed may be split in images and the images may be labelled with the position of the radio devices 106 in the image. In another case, if the CV system 104 is a dummy camera, then the visual recognition may be applied at the radio AP 102 side.

Successively, the radio AP 102 may receive a RecordingStartAcknowledge message from the CV system, 104, at step 1004. Successively, the radio AP 102 may send a second message i.e. StartallPilotsFrameTrasmission notification message to a radio device 106, at step 1006. The StartallPilotsFrameTrasmission notification may include an information element (IE) with the configuration of the radio signal frame that needs to be sent to the radio AP 102 by the radio device 106. In one example embodiment, the radio signal frame may consist of only pilot symbols with transmission parameters specified in the second message and which may be adapted to the radio device concurrent traffic transmission. Further, the second message may include the frequency with which the radio signal frame should be transmitted and which is to be set per implementation.

Successively, the radio AP 102 may receive a video feed identifying radio devices 106 within a field of view of the CV system 104, from the CV system 104, at step 1008. In one example embodiment, the radio AP 102 may receive the recorded image/video along with the label/information on the visual recognition of the radio devices 106. In one case, if the CV system 104 is a dummy, then the message may contain only the video feed and the recognition may be performed and the information may be stored at the radio AP 102.

Successively, the radio AP 102 may periodically receive allPilotsFrame from the transmitting radio device 106, at step 1010. In one example embodiment, the radio AP 102 may determine and store the CIR for each received radio signal frame. It should be noted that the periodicity of the allPilotsFrame may be lower with considerate on the resource allocations and may be maintained acceptable. In one example embodiment, if the data traffic is lower, then the frequency of frames may be decided to be superior to the frequency of allPilotsFrame sent when the radio devices traffic is high. Successively, the radio AP 102 may send StopRecording message to the CV system 104, at step 1012. Successively, the radio AP 102 may receive StopRecordingAcknowledge message from the CV system 104, at step 1014. Thereafter, the radio AP 102 may send StopallPilotsFrameTransmission notification to the radio devices 106, to stop the ongoing procedure, at step 1016.

In one example embodiment, the disclosed method may be used to spot rogue users, radio devices that infiltrate the network. It should be noted that the rogue radio devices may be connected to the radio AP 102. Further, using the disclosed system and method, the CV system 104 may detect that the radio devices (UEs) are not the ones with the valid CIR print. In another example embodiment, the disclosed method may be used to identify the active radio devices from a plurality of radio devices. Such identification may be done as the active radio device is in the connected state and may transmit over radio. In yet another example embodiment, the disclosed method may be used to track a radio device and notify the radio AP 102 upon eventual blockages arising in future. In yet another example embodiment, the disclosed method may be used to build a visual representation of the CIR, equivalent to visual heat-maps, with the help of the video feed. In one example embodiment, the disclosed method, system, and apparatus may be used as a key enabler for techniques using the CV system 104 for enhancing radio management.

It will be apparent to one skilled in the art the role of the radio device 106 and the radio AP 102 may be inversed, then the radio device 106 may be trained to generate bounding boxes with the recognized radio AP 102. Thereafter, the radio AP 102 may measure the CIRs, without departing from the scope of the disclosure

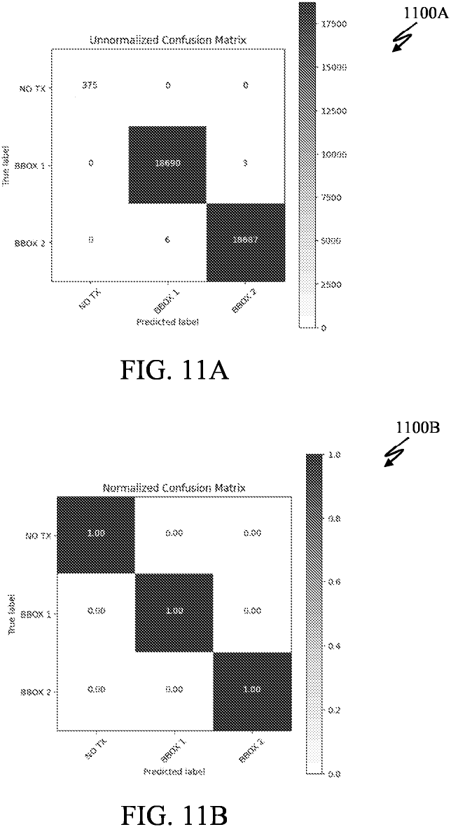

FIGS. 11A and 11B illustrate graphs showing a comparison between an un-normalized confusion matrix and a normalized confusion matrix in terms of a true label and a predicted label, according to an example embodiment. In a first experiment, it may be considered to keep Universal Software Radio Peripheral (USRP) i.e. two USRPs static and measurements may be made in two different locations. It should be noted that half of the USRP with the BBOX 1 is transmitting, the other half the USRP with BBOX 2 is transmitting. In one example embodiment, USRPS may be Ettus B210. As shown in graphs 1100A and 1100B, the confusion matrix shows that if the system is confusing two classes i.e. commonly mis-labelling one class as another class. Further, 99.527 instances (i.e. 72.50%) for training and 37.761 instances (i.e. 27.50%) for validation, are considered in the first experiment, as shown in the graphs 1100A and 1100B. Thereafter, during the validation, the system has an accuracy of 99.97% and a F1 score of 99.98%. It should be noted that the USRPs may send a pilot-based frame with a Binary Phase Shift Keying (BPSK) modulation using an orthogonal frequency-division multiplexing (OFDM) transmission at 1 GHz.

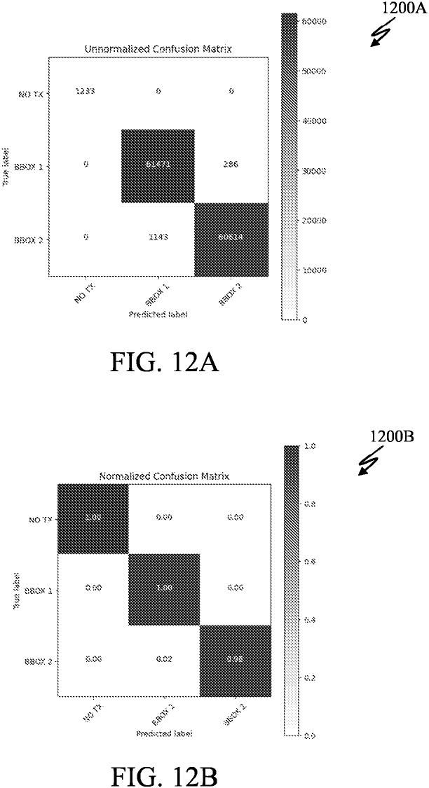

FIGS. 12A and 12B illustrate graphs showing a comparison between an un-normalized confusion matrix and a normalized confusion matrix in terms of a true label and a predicted label, according to an example embodiment. In a second experiment, it may be considered to keep Universal Software Radio Peripheral (USRP) i.e. two USRPs static and measurements may be made in four different locations. As shown in graphs 1200A and 1200B, 381.880 instances (i.e. 75.38%) for training and 124.747 instances (i.e. 24.62%) for validation, are considered in the second experiment. Thereafter, during the validation, the system has an accuracy of 98.88% and a F1 score of 98.88%.

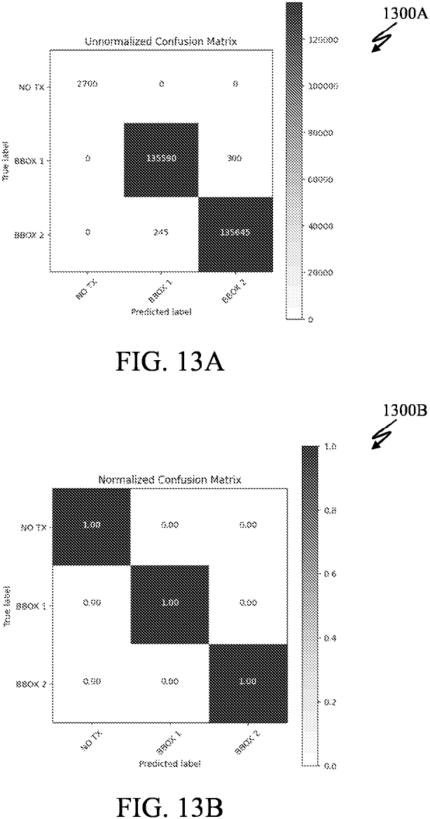

FIGS. 13A and 13B illustrate graphs showing a comparison between an un-normalized confusion matrix and a normalized confusion matrix in terms of a true label and a predicted label, according to an example embodiment. In a third experiment, it may be considered to keep Universal Software Radio Peripheral (USRP) i.e. two USRPs static and measurements may be made in nine different locations. As shown in graphs 1300A and 1300B, 1.207.833 instances (i.e. 81.48%) for training and 274.480 instances (i.e. 18.52%), are considered in the third experiment. Thereafter, during the validation, the system has an accuracy of 99.80% and a F1 score of 99.86%.

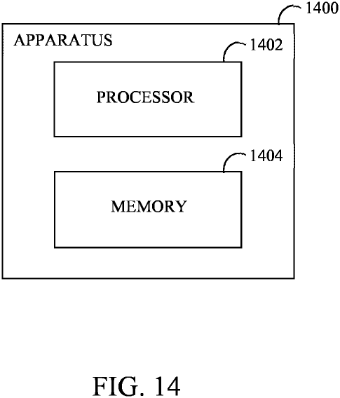

FIG. 14 is a block diagram showing one or more components of an apparatus 1400, according to an example embodiment. The apparatus 1400 may include a processor 1402 and a memory 1404.

The processor 1402 includes suitable logic, circuitry, and/or interfaces that are operable to execute instructions stored in the memory to perform various functions. The processor 1402 may execute an algorithm stored in the memory for identifying transmitting radio devices from a plurality of radio devices 106, within a video feed, utilizing machine learning (ML) algorithm. The processor 1402 may also be configured to decode and execute any instructions received from the CV system 104 or the plurality of radio devices 106. The processor 1402 may include one or more general-purpose processors (e.g., INTEL® or Advanced Micro Devices® (AMD) microprocessors) and/or one or more special-purpose processors (e.g., digital signal processors or Xilinx® System On Chip (SOC) Field Programmable Gate Array (FPGA) processor). The processor 1402 may be further configured to execute one or more computer-readable program instructions, such as program instructions to carry out any of the functions described in the description.

Further, the processor 1402 may make decisions or determinations, generate frames, packets or messages for transmission, decode received radio signals or video feed for further processing, and other tasks or functions described herein. The processor 1402, which may be a baseband processor, for example, may generate messages, packets, frames or other signals for transmission via wireless transceivers. It should be noted that the processor 1402 may control transmission of signals or messages over a wireless network, and may control the reception of signals or messages, etc., via a wireless network (e.g., after being down-converted by wireless transceiver, for example). The processor 1402 may be (or may include), for example, hardware, programmable logic, a programmable processor that executes software or firmware, and/or any combination of these.

Further, using other terminology, the processor 1402 along with the transceiver may be considered as a wireless transmitter/receiver system, for example.

The memory 1404 stores a set of instructions and data. Further, the memory 1404 includes one or more instructions that are executable by the processor to perform specific operations. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, cloud computing platforms (e.g. Microsoft Azure and Amazon Web Services, AWS), or other type of media/machine-readable medium suitable for storing electronic instructions.

It will be apparent to one skilled in the art that the above-mentioned components of the apparatus 1400 have been provided only for illustration purposes. In one example embodiment, the apparatus 1400 may include an input device, output device etc. as well, without departing from the scope of the disclosure.

Embodiments of the present disclosure may be provided as a computer program product, which may include a computer-readable medium tangibly embodying thereon instructions, which may be used to program a computer (or other electronic devices) to perform a process. The computer-readable medium may include, but is not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions (e.g., computer programming code, such as software or firmware). Moreover, embodiments of the present disclosure may also be downloaded as one or more computer program products, wherein the program may be transferred from a remote computer to a requesting computer by way of data signals embodied in a carrier wave or other propagation medium via a communication link (e.g., a modem or network connection).

The detailed description section of the application should state that orders of method steps are not critical. Such recitations would later support arguments that the step order in a method claim is not critical or fixed. Features that are described and/or illustrated with respect to one embodiment may be used in the same way or in a similar way in one or more other embodiments and/or in combination with or instead of the features of the other embodiments.

While the above embodiments have been illustrated and described, as noted above, many changes can be made without departing from the scope of the example embodiments. For example, aspects of the subject matter disclosed herein may be adopted on alternative operating systems. Accordingly, the scope of the example embodiments is not limited by the disclosure of the embodiment. Instead, the example embodiments should be determined entirely by reference to the claims that follow.

What is claimed is:

1. An apparatus for identifying transmitting radio devices from a plurality of radio devices within a video feed, the apparatus comprising:
at least one processor; and
at least one non-transitory memory storing instructions that, when executed with the at least one processor, cause the apparatus to perform:
receiving, from the plurality of radio devices, at least one radio signal identifying a transmitting radio device;
receiving, from a computer vision apparatus, a video feed identifying radio devices within a field of view of the computer vision apparatus;
extracting a first set of features from the received at least one radio signal;
extracting a second set of features from the received video feed; and
providing the first set of features and the second set of features as an input to a machine learning algorithm to obtain a relationship between the transmitting radio device and the radio devices identified in the video feed.

2. The apparatus according to claim 1, wherein the at least one radio signal comprises a channel impulse response; of the transmitting radio device, and wherein the instructions, when executed with the at least one processor, cause the apparatus to perform extracting the first set of features with determining a phase and a magnitude of the channel impulse response, and determining from the magnitude of the channel impulse response, a peak position and a peak value.

3. The apparatus according to claim 1, wherein the instructions, when executed with the at least one processor, cause the apparatus to perform extracting the second set of features with performing visual detection on the video feed using a mask region-based convolutional neural network, to determine a respective bounding box for the radio devices in the video feed, the bounding box comprising an identifier.

4. The apparatus according to claim 1, wherein the instructions, when executed with the at least one processor, cause the apparatus to perform
periodically receiving radio signals and the video feed, the radio signals being received with a first frequency and the video feed being received with a second frequency during a reception period, wherein the first frequency is higher than the second frequency;
averaging the radio signals received to obtain an averaged radio signal; and
merging the first set of features extracted from the averaged radio signal with the second set of features extracted from the video feed, using timestamps, to obtain the input for the machine learning algorithm.

5. The apparatus according to claim 3, wherein the learning algorithm is implemented using a random forest classifier, having a plurality of classification trees, wherein the instructions, when executed with the at least one processor, cause the classification trees to process a subset of the first set of features and the second set of features.

6. The apparatus according to claim 5, wherein the instructions, when executed with the at least one processor, cause the random forest classifier to produce an output comprising one of a Boolean value indicative of whether the transmitting radio device is identified in the video feed or a mapping identifying to which bounding box identifier the transmitting radio device belongs to.

7. The apparatus according to claim 5, wherein the random forest classifier is configured to output a probability distribution over the bounding boxes in the video feed, indicating the probability of the transmitting radio device being one of the radio devices identified in the bounding boxes.

8. An apparatus, comprising:
at least one processor;
at least one non-transitory memory storing instructions that, when executed with the at least one processor, cause the apparatus to perform:
obtaining a plurality of sets of training data, wherein the set of the plurality of training data comprises:
a channel impulse response and channel impulse response-related data for a transmitting radio device, wherein the channel impulse response-related data comprises at least one of a channel impulse response phase, a channel impulse response magnitude, value, and index of a channel impulse response magnitude peak, and mean value and standard deviation of channel impulse response magnitude vector;
a plurality of bounding box identifiers ID = 1, ..., N, the bounding box identifiers corresponding to a radio device in a field of view of a computer vision apparatus ; and
a label, indicating which radio device from the plurality of radio devices identified with the bounding box identifiers corresponds to the transmitting radio device; and
training random forest classifier algorithm with combining an exhaustive search over random forest classifier parameters values, to obtain, from the plurality of sets of training data, a best number of classification trees and a best maximum depth of the classification trees with respect to two corresponding metrics.

9. The apparatus of claim 8, wherein the instructions, when executed with the at least one processor, cause the apparatus to obtain the plurality of sets of training data with:
sending a first message to the computer vision apparatus, to instruct the computer vision apparatus to start recording, the first message comprising a start time for the recording;
sending a second message to the radio device, to request transmission of a radio signal frame from the radio device, the second message containing a configuration of the radio signal frame to be transmitted with the radio device;
receiving, from the computer vision apparatus, a video feed, the video feed identifying radio devices within a field of view of the computer vision apparatus; and
receiving, from the transmitting radio device, at least one radio signal frame, and storing for the received radio signal frame the computer impulse response.

10. A method for identifying transmitting radio devices from a plurality of radio devices within a video feed, the method comprising:
receiving, from the plurality of radio devices, at least one radio signal identifying a transmitting radio device;
receiving, from a computer vision apparatus, a video feed identifying radio devices within a field of view of the computer vision apparatus;
extracting a first set of features from the received at least one radio signal;
extracting a second set of features from the received video feed; and
providing the first set of features and the second set of features to a machine learning algorithm, to obtain a relationship between the transmitting radio device and the radio devices identified in the video feed.

11. The method of claim 10, wherein the at least one radio signal comprises a channel impulse response of the transmitting radio device, the method further comprising extracting the first set of features with determining a phase and a magnitude of the channel impulse response, and determining from the magnitude of the channel impulse response a peak position and a peak value.

12. The method of claim 10 further comprising extracting the second set of features with performing visual detection on the video feed using a mask region-based convolutional neural network, to determine a respective bounding box for the radio device in the video feed, the bounding box comprising an identifier.

13. A method comprising:
obtaining a plurality of sets of training data, wherein the sets of the plurality of training data comprises:
a channel impulse response and channel impulse response-related data for a transmitting radio device, wherein the channel impulse response-related data comprises at least one of a channel impulse response phase, a channel impulse response magnitude, a value and index of a channel impulse response magnitude peak, and a mean value and standard deviation of channel impulse response magnitude vector;
a plurality of bounding box identifiers ID = 1, ..., N, the bounding box identifiers corresponding to a radio device in a field of view of a computer vision apparatus; and
a label indicating which radio device from the plurality of radio devices identified with the bounding box identifier corresponds to the transmitting radio device; and
training a random forest classifier algorithm with combining an exhaustive search over random forest classifier parameter values, to obtain from the plurality of sets of training data a best number of classification trees and a best maximum depth of the classification trees with respect to two metrics.

14. A system comprising at least one radio access point, a plurality of radio devices, and at least one computer vision apparatus, wherein the at least one radio access point is configured to perform the method of claim 10.

15. A non-transitory program storage device readable by an apparatus tangibly embodying a program of instructions executable with the apparatus for performing operations comprising:
receiving, from a plurality of radio devices, at least one radio signal frame identifying a transmitting radio device;
receiving, from a computer vision apparatus, a video feed identifying radio devices within a field of view of the computer vision apparatus ;
extracting a first set of features from the received at least one radio signal frame;
extracting a second set of features from the received video feed; and
providing the first set of features and the second set of features to a machine learning algorithm, to obtain a relationship between the transmitting radio device and the radio devices identified in the video feed.
